(19) United States
(12) Patent Application Publication
(10) Pub. No.: US 2014/0310102 A1
(43) Pub. Date: Oct. 16, 2014

(54) ELECTRONIC DEVICE FOR SYNTHESIZING ADVERTISING CONTENTS TO IMAGE OF POINT OF INTEREST AND METHOD THEREOF

(71) Applicant: Samsung Electronics Co., Ltd., Suwon-si (KR)

(72) Inventor: Ik-Hwan CHO, Suwon-si (KR)

(73) Assignee: Samsung Electronics Co., Ltd., Suwon-si (KR)

(21) Appl. No.: 14/149,237

(22) Filed: Jan. 7, 2014

(30) Foreign Application Priority Data
Apr. 16, 2013 (KR) 10-2013-0041592

(51) Int. Cl. G06Q 30/02

(52) U.S. Cl. CPC G06Q 30/0261
USPC 705/14.58

(57) ABSTRACT

An electronic device for synthesizing advertising contents to an image of a Point of Interest (POI) and a method thereof are provided. The method includes displaying an image of a POI to which at least one contents are synthesized, sensing a motion input to the displayed image of the POI, and displaying the image of the POI that has been changed according to the sensed motion.

### CROSS-REFERENCE TO RELATED APPLICATION(S)

This application claims the benefit under 35 U.S.C. §119(a) of a Korean patent application filed on Apr. 16, 2013 in the Korean Intellectual Property Office and assigned Serial No. 10-2013-0041592, the entire disclosure of which is hereby incorporated by reference.

### TECHNICAL FIELD

The present disclosure relates to an electronic device for synthesizing advertising contents, so as to combine the advertising contents, and a method thereof.

### BACKGROUND

As functions of electronic devices have been developed, users of the electronic devices may conduct a search for a Point of Interest (POI) as or using a 3 Dimensional (3D) image using their electronic device. Accordingly, a location-based advertising system, which inserts advertising contents into an image of a POI, has also been developed. However, there is a problem in that a related-art electronic device may not provide satisfaction to a user thereof by providing images in which advertising contents are mixed with limited images of an area that is input as a POI.

Therefore, there is a need to develop an apparatus and method for preventing an image of a POI from being damaged or altered in an unwanted manner while simultaneously providing an image for enhancing an advertising effect.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to solve at least the above-mentioned problems and/or disadvantages and to provide at least the advantages described below. Accordingly, an aspect of the present disclosure is to provide an apparatus and method configured to improve convenience of a user by synthesizing advertising contents to a detected advertising region from among image regions of a Point of Interest (POI) and configured to transmit an advertising message effectively without obscuring an image of the POI.

Another aspect of the present disclosure is to provide an apparatus and method for meeting satisfaction of a sponsor by transmitting a detailed advertising message when advertising contents synthesized to an image of a POI are selected.

In accordance with an aspect of the present disclosure, an operation method of an electronic device is provided. The operation method includes displaying an image of a POI, to which at least one contents are synthesized, sensing a motion input to the displayed image of the POI, and displaying the image of the POI that has been changed according to the sensed motion.

In accordance with an aspect of the present disclosure, an operation method of a server is provided. The operation method includes searching for contents that are at least one of registered and available online and that correspond to a POI in order to synthesize at least one contents to an image of the POI that is requested by an electronic device, detecting an advertising region from among image regions of the POI in order to synthesize the at least one searched contents to the image of the POI, and synthesizing the contents to the detected advertising region.

In accordance with another aspect of the present disclosure, an electronic device is provided. The electronic device includes a touch screen configured to display an image of a POI, to which at least one contents are synthesized, configured to sense a motion input to the displayed image of the POI, and configured to display the image of the POI that has been changed according to the sensed motion and a processor unit configured to control information displayed and sensed on the touch screen.

In accordance with another aspect of the present disclosure, a server is provided. The server includes a controller configured to search contents that is at least one of registered and available online and that corresponds to a POI in order to synthesize at least one contents to an image of the POI requested by an electronic device, configured to detect an advertising region from among image regions of the POI in order to synthesize the at least one searched contents to the image of the POI, and configured to synthesize the contents to the detected advertising region and a storage unit configured to store information controlled by the controller.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an electronic device and a server which synthesize advertising contents to an image of a Point of Interest (POI) according to an embodiment of the present disclosure;

FIGS. 2A, 2B, and 2C are screens illustrating a process of synthesizing advertising contents to an image of a POI and displaying the synthesized image in an electronic device according to an embodiment of the present disclosure;

FIGS. 3A, 3B, and 3C are screens illustrating a process of synthesizing advertising contents to an image of a POI and displaying the synthesized image in an electronic device according to an embodiment of the present disclosure;

FIGS. 4A, 4B, and 4C are screens illustrating a process of synthesizing advertising contents to an image of a POI and displaying the synthesized image in an electronic device according to an embodiment of the present disclosure;

FIGS. 5A. 5B, 5C, and 5D are screens illustrating a process of synthesizing advertising contents to an image of a POI and displaying the synthesized image in an electronic device according to an embodiment of the present disclosure;

FIGS. 6A, 6B, 6C, and 6D are screens illustrating a process of synthesizing advertising contents to an image of a POI and displaying the synthesized image in an electronic device according to an embodiment of the present disclosure;

FIGS. 7A, 7B, and 7C are screens illustrating a process of synthesizing advertising contents to an image of a POI and displaying the synthesized image in an electronic device according to an embodiment of the present disclosure;

FIGS. 8A and 8B illustrate a process of detecting advertising regions in a server according to an embodiment of the present disclosure;

FIG. 9 is a flowchart illustrating a process of synthesizing advertising contents to an image of a POI and displaying the synthesized image in an electronic device according to an embodiment of the present disclosure;

FIG. 10 is a flowchart illustrating a process of synthesizing advertising contents to an image of a POI and transmitting the synthesized image to an electronic device in a server according to an embodiment of the present disclosure;

FIG. 11A is a flowchart illustrating a process of synthesizing advertising contents to an image of a POI in an electronic device according to an embodiment of the present disclosure;

FIG. 11B is a block diagram illustrating configuration of an electronic device for synthesizing advertising contents to an image of a POI according to an embodiment of the present disclosure;

FIG. 12A is a flowchart illustrating a process of synthesizing advertising contents to an image of a POI in a server according to an embodiment of the present disclosure;

FIG. 12B is a block diagram illustrating configuration of a server for synthesizing advertising contents to an image of a POI according to an embodiment of the present disclosure;

FIG. 13 is a block diagram illustrating configuration of an electronic device according to an embodiment of the present disclosure; and

FIG. 14 is a block diagram illustrating configuration of a server according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

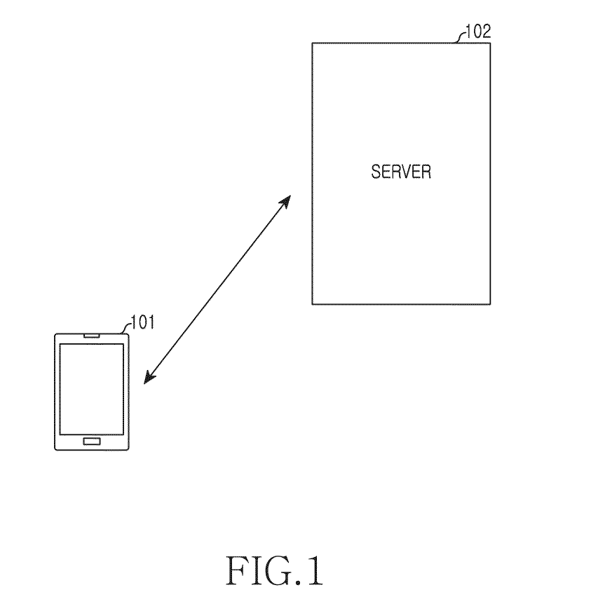

FIG. 1 illustrates an electronic device and a server which synthesize advertising contents to an image of a Point of Interest (POI) according to an embodiment of the present disclosure.

Referring to FIG. 1, an electronic device 101 and a server 102 are connected in real time. The electronic device 101 may request the server 102 to transmit an image of a POI in real time. A user of the electronic device may input information identifying the POI into the electronic device using an input device (not shown), such as a keyboard, a microphone, a touch screen, a button, or any other similar and/or suitable input device for inputting information to an electronic device. The server 102 may synthesize at least one content to the image of the POI received from the electronic device 101 and may transmit the synthesized image to the electronic device 101.

First of all, the electronic device 101 may receive a title of the POI and may request the server 102 to transmit an image of the received POI. In more detail, when a title of the POI is received, the electronic device 101 may request the server 102 to transmit an image of the POI so as to display a 3 Dimensional (3D) image of the received POI. Herein, the electronic device 101 may request the server 102 to transmit the 3D image of the POI so as to display the 3D image of the POI. However, the electronic device 101 may also request the server 102 to transmit a 2D image of the POI or any other similar and/or suitable image of the POI.

Thereafter, the electronic device 101 may receive the image of the POI, to which at least one contents are synthesized, from the server 102 and display the received image of the POI. In more detail, the electronic device 101 may receive a 3D image of the POI, to which at least one advertising contents are synthesized, from the server 102 and may display the received 3D image of the POI on a touch screen (not shown) that may be included in the electronic device 101. The touch screen may be included in any suitable display device (not shown) of the electronic device, such as an Light Emitting Diode (LED) display, an Organic LED (OLED) display, a Liquid Crystal Display (LCD), or any other similar and/or suitable display device. When an “A area” is received as a POI, the electronic device 101 may receive a 3D image of the “A area”, to which at least one advertising contents are synthesized, from the server 102.

Herein, the displaying of the image of the POI, to which at least the one advertising contents, may include displaying the image of the POI where at least the one advertising contents are synthesized to at least one synthesizable region among image regions of the POI so as not to hide the image of the POI. That is, the electronic device 101 may display the image of the POI where the advertising contents are synthesized to a synthesizable region among the image regions of the POI on the touch screen.

Thereafter, the electronic device 101 may sense a motion input to the image of the POI displayed on the touch screen. In more detail, the electronic device 101 may detect gestures such as a touch, a drag, a release, and any other similar and/or suitable gesture, may detect scroll operations such as a scroll-up operation, a scroll-down operation, and any other similar and/or suitable scroll operations, or may sense scaling operations including a magnifying operation, a de-magnifying operation, a zoom-in operation, a zoom-out operation, or any other similar and/or scaling operation on a certain region of the image of the POI. For example, the electronic device 101 may receive a motion for magnifying a certain region of a 3D image of an “A area” displayed on the touch screen and may also receive a scrolling motion for displaying a region which is not displayed on the touch screen.

The electronic device 101 may request the server 102 to transmit an image of the POI, which may be changed according to the sensed motion and the electronic device 101 may receive the requested image of the POI from the server 102. In more detail, when the electronic device 101 senses that a specific motion is input to the image of the POI, then the electronic device 101 may request the server 102 to transmit the image of the POI and may receive the requested image of the POI from the server 102 to display the image of the POI, which is changed according to the sensed motion.

The electronic device 101 may receive the changed image of the POI from the server 102 and may display the changed image of the POI on the touch screen. For example, there may be a case having a 3D image of the “A area” is displayed on the touch screen and advertising contents of a “B store” are synthesized to the displayed 3D image. In such a case, when the advertising contents of the “B store” displayed on the touch screen are selected, then the electronic device 101 may reproduce a moving picture including information such as various menus of the “B store”, ingredients added to respective foods, prices of respective menus, or any other similar and/or suitable information corresponding to the “B store”.

For example, there may be a case where a 3D image of the “A area” is displayed on the touch screen of the electronic device 101 and a guide message for providing directions a position of the “B” store is included in the displayed 3D image. In such a case, the electronic device 101 may display the guide message for guiding the position of the “B” store together on the changed 3D image, which is not displayed on the touch screen.

The server 102 may receive the request to transmit the image of the POI from the electronic device 101 and may search contents included in an online website and/or store of the POI so as to synthesize at least one contents to the requested image of the POI. In more detail, when the request to transmit the image of the POI is received from the electronic device 101, the server 102 may search advertising contents included in the online website and/or store of the POI so as to call the stored 3D image of the POI and synthesize the searched advertising contents to the called 3D image. For example, there may be a case where stores which register advertising messages in 3D images of the “A area” are a “B theater”, a “C bookstore”, and a “D restaurant”. In such a case, when the server 102 receives the request to transmit the 3D image of the “A area” from the electronic device 101, the server 102 may search advertising contents corresponding to the “B theater”, the “C bookstore”, and the “D restaurant” which are registered on online of the 3D image of the “A area”.

Thereafter, the server 102 may detect an advertising region from among image regions of the POI so as to synthesize at least the one searched region to the image of the POI. Herein, the advertising region may be a region where it is convenient for a user to verify an image of a POI although registered advertising contents are synthesized among image regions of the POI. For example, the advertising region may be at least one of a wall of a building, a road region, a sidewalk region where there is no structure, a region whose image is not complicated such as a sea and a river, an advertising region like a real billboard, or any other similar and/or suitable region of an image.

That is, the server 102 may perform a process described below in order to detect an advertising region from among image regions of the POI. First, the server 102 may detect a surface of a set size or more from a 3D image which is an image of a POI. In more detail, the server 102 may detect a plane or a curve, which has a size greater than or equal to a set size, from a 3D image of the POI using a RANdom SAmple Consensus (RANSAC) algorithm. However, the present disclosure is not limited thereto, and the server 102 may detect planes, planar surfaces, and curves according to any suitable and/or similar algorithm, process and/or method. That is, the server 102 may display one plane of a specific object which exists on a 3D space as a 3D mesh, may compare a position of the displayed 3D mesh with positions of other meshes which exist on the 3D space, and may determine whether the displayed 3D mesh and other meshes are located on the same plane.

When detecting the surface having the size greater than or equal to the set size from the 3D image, which is the image of the POI, the server 102 may detect a texture image configuring the detected surface. Herein, the texture image may be defined as a specific pattern image on a plane region of a 3D space. That is, the 3D image may be shown as a shape in which a texture image is covered on a 3D space which is formed of a mesh.

Thereafter, the server 102 may calculate image texture regularity of the detected texture image. In more detail, the server 102 may calculate the image texture regularity of the detected texture image using a regularity filtering algorithm or any other similar and/or suitable algorithm or method. That is, the server 102 may generate a pixel value difference as a histogram in a specific direction, may analyze a pattern of the histogram, and may calculate the image texture regularity of the detected texture image.

When it is determined that the calculated image texture regularity has a value greater than or equal to a set value, the server 102 may detect the detected texture image as an advertising region. Herein, the enhancing of the image texture regularity may be done such that the detected texture image is suitable for an advertising region because the detected texture image is shown as an image which is similar to a plane or a curve.

When detecting the advertising region, the server 102 may synthesize advertising contents to the detected advertising region and may transmit the image of the POI, to which at least one advertising contents are synthesized. Herein, the above-described advertising contents may be a fixed advertising image, a moving advertising icon, a guide message for verifying a position of the nearest store, or any other similar and/or suitable advertising contents on the image of the POI.

A related-art electronic device may provide an advertising image when displaying an input image of a POI. However, there is an inconvenience in that a user of the related-art electronic device does not verify an image of a POI at a glance because the image of the POI and the advertising image are overlapped and provided together. Also, there is an inconvenience in that an advertising effect is lowered because a sponsor does not transmit a desired advertising message to the user effectively.

However, there is an advantage in that the electronic device according to an embodiment of the present disclosure may improve convenience of a user thereof by synthesizing advertising contents to a detected advertising region from among image regions of a POI and by effectively transmitting an advertising message without hiding an image of the POI. Also, there is an advantage in that the electronic device may optimize an advertising effect by effectively transmitting an advertising message selected by a sponsor to the user.

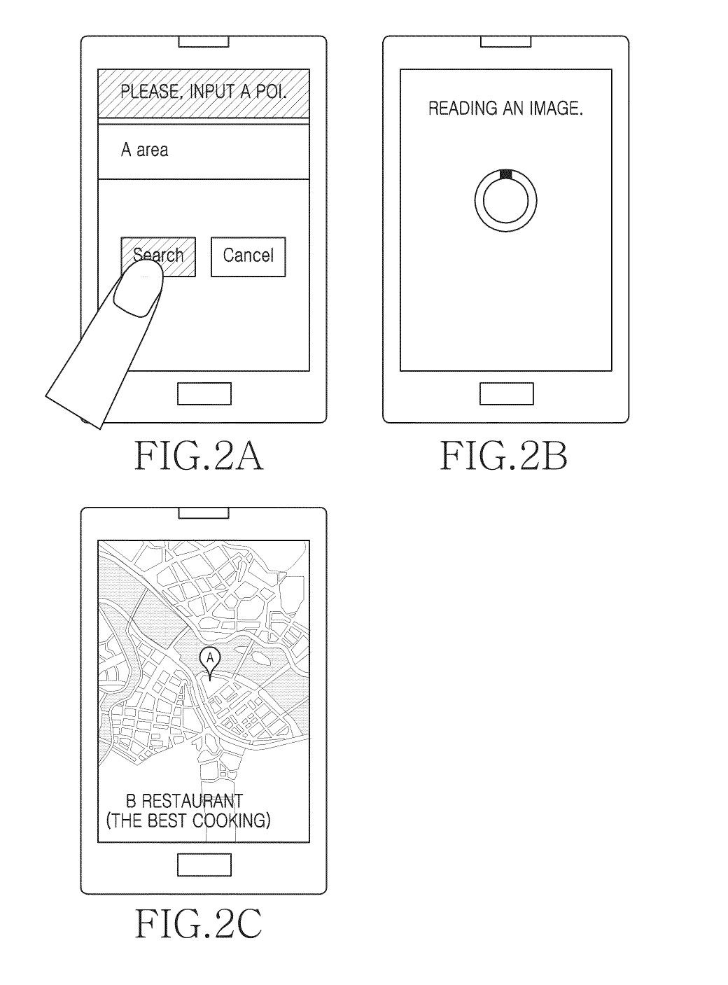

FIGS. 2A, 2B, and 2C are screens illustrating a process of synthesizing advertising contents to an image of a POI and displaying the synthesized image in an electronic device according to an embodiment of the present disclosure.

Referring to FIG. 2A, an electronic device may receive a command for instructing the electronic device to display a 3D image of a POI and display a guide message for allowing a user to input a POI to the touch screen of the electronic device.

The electronic device may receive the POI and may receive a command for instructing the electronic device to search the received POI. For example, as shown in FIG. 2A, the electronic device receives an “A area” as the POI and allows the user to select a “search” region displayed on the touch screen.

As shown in FIG. 2B, the electronic device may request a server to transmit an input 3D image of the POI so as to display the 3D image of the POI, which is input as the POI, on the touch screen. Herein, the electronic device may request the server to transmit the 3D image of the POI so as to display the 3D image of the POI. However, the electronic device may also request a server to transmit a 2D image of the POI. For example, when a “department store which is located in an A area” is input as the POI, the electronic device may request the server to transmit a 3D image of at least one department store which is located in the A area.

As shown in FIG. 2C, the electronic device may receive the image of the POI, to which at least one contents are synthesized, from the server and display the received image of the POI. In more detail, the electronic device may receive the 3D image of the POI, to which at least the one contents are synthesized, from the server and the electronic device may display the received image of the POI on the touch screen. For example, when an “A area”, which is adjacent to a shoreline next to a sea region shown in the received image, is input as the POI, then the electronic device may display a 3D image of the “A area”, to which advertising contents such as a “B restaurant (the best cooking)” are synthesized, on the sea region of the received image.

Therefore, there is an advantage in that the user who uses the electronic device may verify the POI directly because the 3D image of the “A area”, which is the POI, is not hidden by the advertising contents, such as the “B restaurant (the best cooking)”. Also, there is an advantage in that the electronic device may optimize an advertising effect because a sponsor does not provide inconvenience to the user and advertising contents engage user's eyes at a glance although advertising contents are synthesized to a sea region.

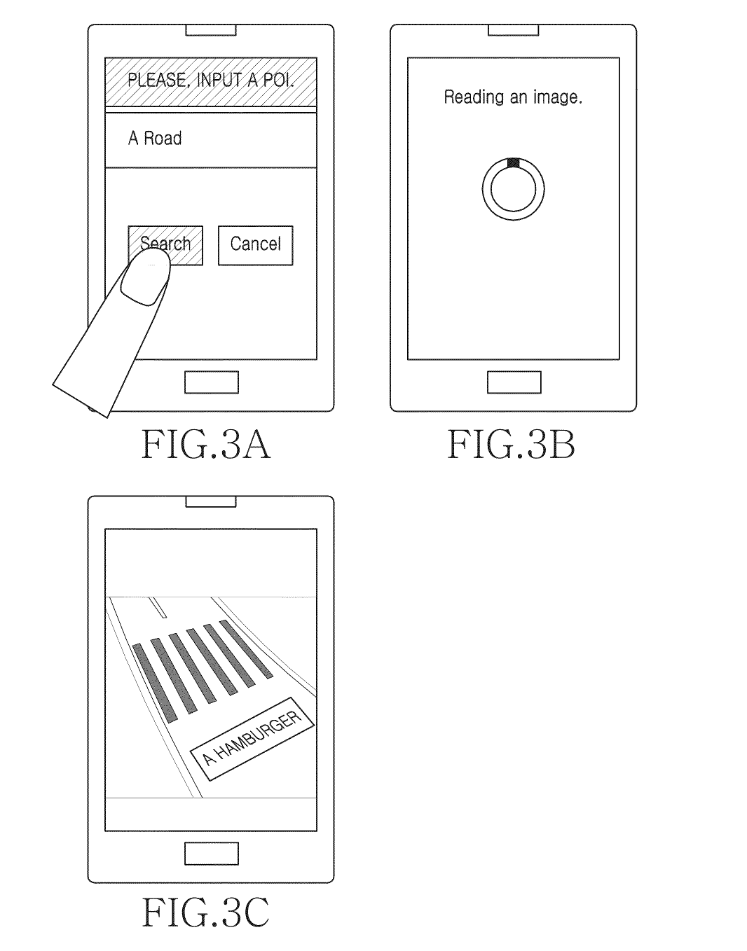

FIGS. 3A, 3B, and 3C are screens illustrating a process of synthesizing advertising contents to an image of a POI and displaying the synthesized image in an electronic device according to an embodiment of the present disclosure.

Referring to FIG. 3A, an electronic device may receive a command for instructing the electronic device to display a 3D image of a POI and display a guide message for allowing a user to input a POI to a touch screen of the electronic device. The touch screen may be any suitable hardware device for receiving a touch input gesture from a user of the electronic device, and may be a capacitance-type touch screen, a resistance-type touch screen, or any other similar and/or suitable touch screen type.

The electronic device may receive the POI and may receive a command for instructing the electronic device to search the received POI. For example, as shown in FIG. 3A, the electronic device receives an “A road” as the POI and allows the user to select a “search” region displayed on the touch screen.

As shown in FIG. 3B, the electronic device may request a server to transmit an input 3D image of the POI in order to display the 3D image of the POI, which is input as the POI, on the touch screen. Herein, the electronic device may request the server to transmit the 3D image of the POI in order to display the 3D image of the POI. However, the electronic device may also request the server to transmit a 2D image, or any other similar and/or suitable image of the POI. For example, when a “store which is located in an A area” is input as the POI, then the electronic device may request the server to transmit a 3D image of at least one store which is located in the A area.

As shown in FIG. 3C, the electronic device may receive the image of the POI, to which at least one contents are synthesized, from the server and the electronic device may display the received image of the POI. In more detail, the electronic device may receive the 3D image of the POI, to which at least the one contents are synthesized, from the server and the electronic device may display the received image of the POI on the touch screen. For example, when an “A road” is input as the POI, then the electronic device may display a 3D image having advertising contents, such as an “A hamburger”, synthesized thereupon to a crosswalk of the “A road”.

Therefore, there is an advantage in that the user who uses the electronic device may verify the POI directly because the 3D image of the “A road”, which is the POI, is not hidden by the advertising contents such as the “A hamburger”. Also, there is an advantage in that the electronic device may optimize an advertising effect because a sponsor does not provide inconvenience to the user and advertising contents engage the user's eyes at a glance although advertising contents are synthesized to the crosswalk of the “A road”.

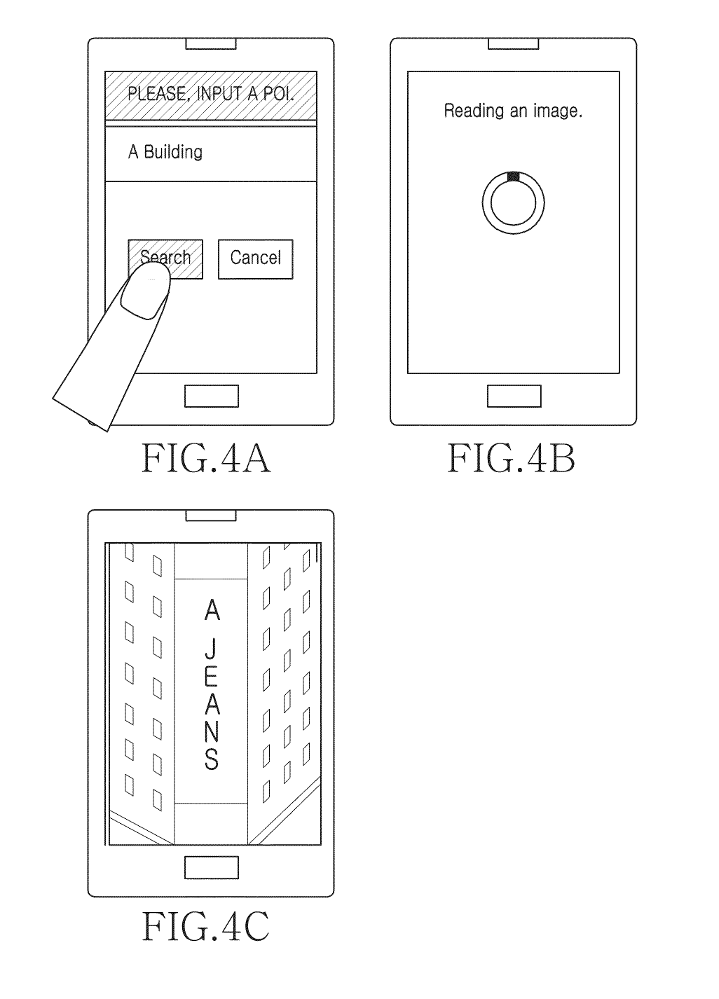

FIGS. 4A, 4B, and 4C are screens illustrating a process of synthesizing advertising contents to an image of a POI and displaying the synthesized image in an electronic device according to an embodiment of the present disclosure.

Referring to FIG. 4A, an electronic device may receive a command instructing the electronic device to display a 3D image of a POI and to display a guide message for allowing a user to input the POI to its touch screen.

The electronic device may receive the POI and may receive a command for instructing the electronic device to search the received POI. For example, as shown in FIG. 4A, the electronic device receives an “A building” as the POI and allows the user to select a “search” region displayed on the touch screen.

As shown in FIG. 4B, the electronic device may request a server to transmit an input 3D image of the POI to be displayed as the 3D image of the POI, which is input as the POI, on the touch screen. Herein, the electronic device may request the server to transmit the 3D image of the POI in order to display the 3D image of the POI. However, the electronic device may also request the server to transmit a 2D image of the POI. For example, when a “theater which is located in an A area” is input as the POI, then the electronic device may request the server to transmit a 3D image of at least one theater which is located in the A area.

As shown in FIG. 4C, the electronic device may receive the image of the POI, to which at least one contents are synthesized, from the server and may display the received image of the POI. In more detail, the electronic device may receive the 3D image of the POI, to which at least the one contents are synthesized, from the server and the electronic device may display the received image of the POI on the touch screen of the electronic device. For example, when an “A building” is input as the POI, then the electronic device may display a 3D image where advertising contents such as an “A jeans” are synthesized to a plane of the “A building”.

That is, it is sufficient for the user to verify information of the “A building”, although the advertising contents such as the “A jeans” are synthesized to a plane of the “A building”, which is input as the POI, and the synthesized image is displayed. Also, as shown in FIG. 4C, advertising contents may be synthesized to a front surface of a building to be seen by the user as a first option, and may be synthesized to other surfaces as a second option. It is not preferable that advertising contents are synthesized to a rear surface of the building not to be seen by the user.

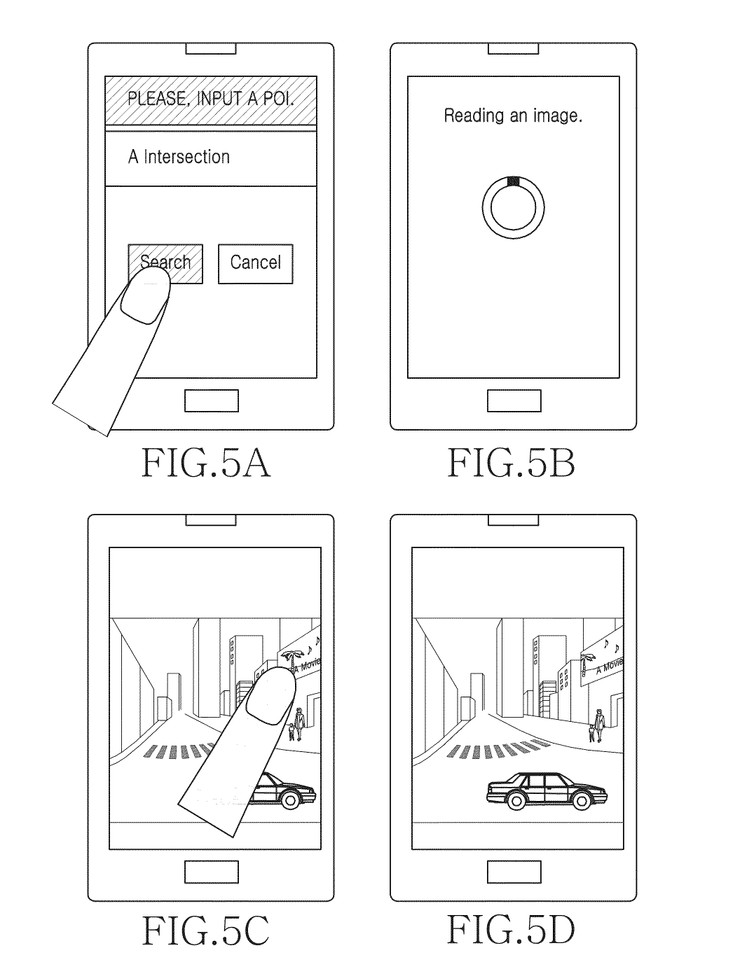

FIGS. 5A, 5B, 5C, and 5D are screens illustrating a process of synthesizing advertising contents to an image of a POI and displaying the synthesized image in an electronic device according to an embodiment of the present disclosure.

Referring to FIG. 5A, the electronic device may receive a command for instructing the electronic device to display a 3D image of a POI and to display a guide message for allowing a user to input the POI to a touch screen included in the electronic device.

Thereafter, the electronic device may receive the POI and may receive a command for instructing it to search the received POI. For example, as shown in FIG. 5A, the electronic device may receive an “A intersection” as the POI and may allow the user to select a “search” region displayed on the touch screen.

As shown in FIG. 5B, the electronic device may request a server to transmit an input 3D image of the POI in order to display the 3D image of the POI, which is input as the POI, on the touch screen. Herein, the electronic device may request the server to transmit the 3D image of the POI in order to display the 3D image of the POI. However, the electronic device may also request the server to transmit a 2D image of the POI. For example, when a “bookstore which is located in an A area” is input as the POI, them the electronic device may request the server to transmit a 3D image of at least one bookstore, which is located in the A area.

As shown in FIG. 5C, the electronic device may allow the user to select advertising contents of an image of the POI, to which at least one contents are received from the server and are displayed so as to be synthesized, and the electronic device may reproduce a set moving picture. In more detail, the advertising contents displayed on the touch screen may be a fixed image. However, when advertising contents which are synthesized to the POI are selected, the electronic device may reproduce a video image. For example, as shown in FIGS. 5C and 5D, when a certain movie advertisement displayed on the electronic device is selected, the electronic device may reproduce a preview of the selected movie as a video image and may provide information about the movie vividly to the user.

That is, it is sufficient for the user to verify information of the “A intersection” although the advertising contents, such as a “movie poster”, are synthesized to a billboard of a specific building of the “A intersection”, which is input as the POI. Also, there is an advantage in that the electronic device may optimize an advertising effect because a sponsor and the displayed advertisement may not provide inconvenience to the user and the movie poster engages the user's eyes at a glance although the movie poster is synthesized to the “billboard” of the “A intersection”.

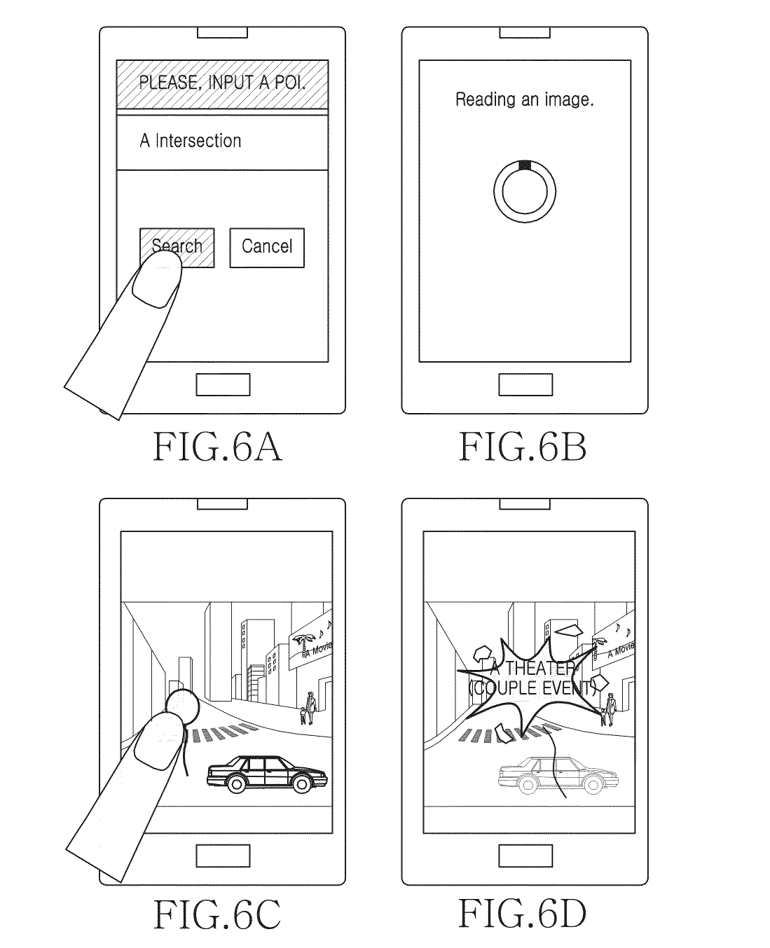

FIGS. 6A, 6B, 6C, and 6D are screens illustrating a process of synthesizing advertising contents to an image of a POI and displaying the synthesized image in an electronic device according to an embodiment of the present disclosure.

Referring to FIG. 6A, an electronic device may receive a command for instructing the electronic device to display a 3D image of a POI and to display a guide message for allowing a user to input the POI to a touch screen included in the electronic device.

Thereafter, the electronic device may receive the POI and may receive a command for instructing the electronic device to search the received POI. For example, as shown in FIG. 6A, the electronic device may receive an “A intersection” as the POI and the electronic device may allow the user to select a “search” region displayed on the touch screen.

As shown in FIG. 6B, the electronic device may request a server to transmit an input 3D image of the POI in order to display the 3D image of the POI, which is input as the POI, on the touch screen. Herein, the electronic device may request the server to transmit the 3D image of the POI to display the 3D image of the POI. However, the electronic device may also request the server to transmit a 2D image of the POI. For example, when a “museum which is located in an A area” is input as the POI, then the electronic device may request the server to transmit a 3D image of at least one museum which is located in the A area.

As shown in FIG. 6C, the electronic device may allow the user to select advertising contents of an image of the POI, to which at least one contents are received from the server and are displayed in a synthesized manner, and may reproduce a set advertising message. In more detail, the advertising message displayed on the touch screen may be a fixed image. However, when advertising contents which are synthesized to the POI are selected, then the electronic device may provide a set advertising message. For one example, as shown in FIGS. 6C and 6D, when a moving balloon displayed on the electronic device is selected, then the electronic device may obtain a user's interest by providing an effect in which the selected balloon is popped as displayed to the user and the electronic device may provide an advertising message such as an “A theater (couple event)” effectively.

For another example, the electronic device may obtain the user's interest such that the user may verify an advertisement actively by moving objects, such as people or cars, on the touch screen. That is, there is an advantage in that the electronic device may enhance an advertising effect from the point of view of the sponsor by showing moving objects to the user who searches a POI.

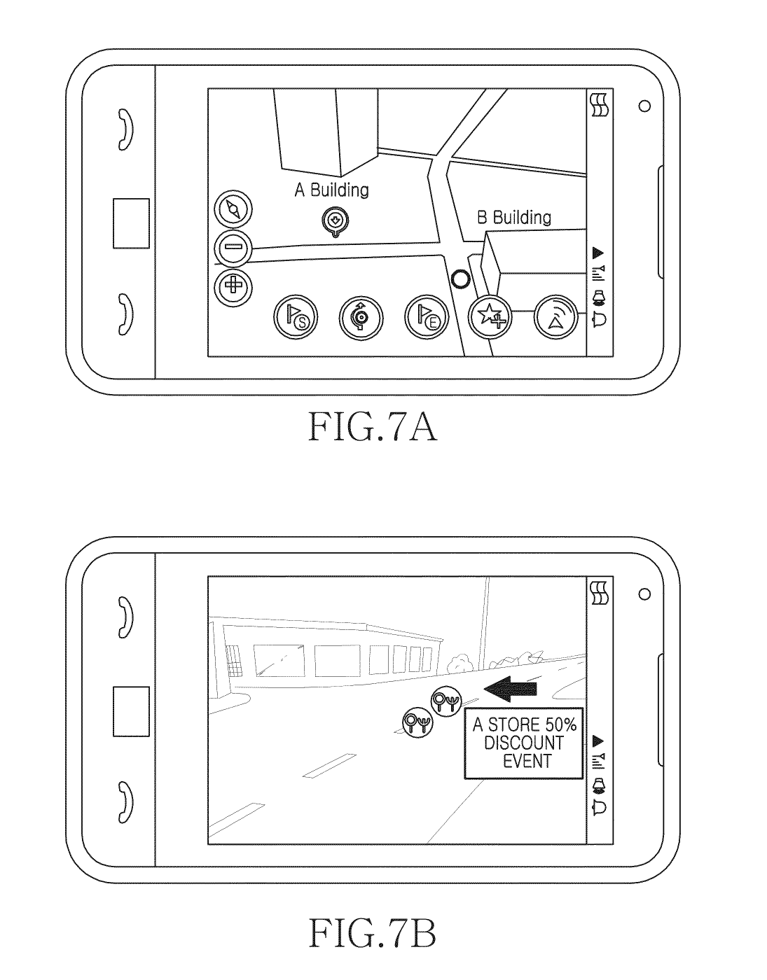

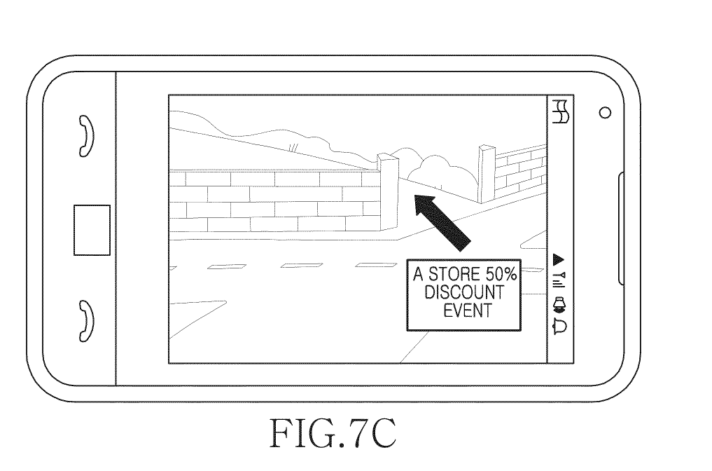

FIGS. 7A, 7B, and 7C are screens illustrating a process of synthesizing advertising contents to an image of a POI and displaying the synthesized image in an electronic device according to an embodiment of the present disclosure.

Referring to FIGS. 7A, 7B, and 7C, it is assumed that the electronic device receives a “C intersection” as a POI and that the electronic device receives a command for instructing the electronic device to display a 3D image of the received “C intersection”.

The electronic device may display the 3D image of the “C intersection”, which is the POI, on its touch screen. For example, as shown in FIG. 7A, the electronic device may display the 3D image of the “C intersection”, which is the POI, including an A building and a B building on the touch screen.

As shown in FIG. 7B, the electronic device may receive an additional touch input on the “C intersection”, which is the POI, and may display a 3D image of a detailed space on the touch screen. For example, as shown in FIG. 7B, the electronic device may sense touch input for displaying a detailed 3D image of a left side centering around the user on the “C intersection”, which is the POI, and the electronic device may display the 3D image, which is located at the left side of the “C intersection”. Herein, the electronic device may synthesize advertising contents, such as an “A store 50% discount event”, to a 3D image and may display the synthesized 3D image on a road which is an advertisable region on the touch screen, wherein the advertisable region is a region of the 3D image which is detected and/or determined to be a region for displaying an advertisement. That is, the electronic device may display a guide message, such as an arrow, together with the advertising contents, such as the “A store 50% discount event”, on the touch screen in order to guide and/or indicate a position of an A store on the “C intersection”.

Thereafter, when the touch input for entering in a direction according to the arrow for guiding the position of the A store is sensed, the electronic device may display a 3D image of a right direction, which is an arrow direction, on the touch screen.

As shown in FIG. 7C, the electronic device may display the advertising contents, such as the “A store 50% discount event”, together with the arrow for guiding and/or indicating the position of the A store at the entrance of the A store on a road which is an advertising region.

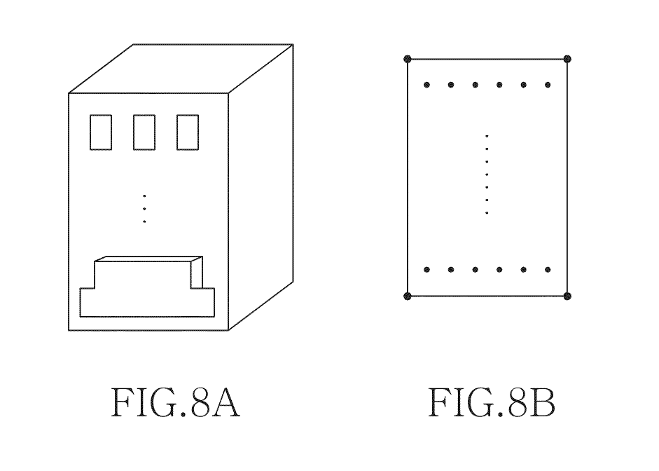

FIGS. 8A and 8B illustrate a process of detecting advertising regions in a server according to an embodiment of the present disclosure.

Referring to FIG. 8A, it is assumed that a POI that is entered as request to transmit a 3D image from an electronic device is an “A building”.

In the above-described assumption, the server may detect a plane or a curve, having a size that is greater than or equal to a set size, from the 3D image of the “A building” using an RANSAC algorithm to detect an advertising region from the 3D image of the “A building”. That is, the server may display one plane of the “A building”, which exists on a 3D space, as a 3D mesh, the server may compare a position of the displayed 3D mesh with positions of other meshes which exist on the 3D space, and the server may determine whether the displayed 3D mesh and the other meshes are located on the same plane.

For example, the server displays one side of the “A building” as a 3D mesh and compares a position of the displayed 3D mesh with positions of other meshes which exist on the 3D space. As a result of the comparison, the server may not detect a front surface of the “A building” as a plane or curve having a size greater than or equal to a set size. However, as shown in FIG. 8B, the server may detect a side surface of the “A building” as a plane having a size greater than or equal to set size.

In order to detect the plane having a size greater than or equal to the set size from the 3D image, which is the image of the POI, the server may detect a texture image configuring the detected plane. Herein, the texture image may be a specific pattern image on a plane region of a 3D space. That is, the 3D image may be shown as a shape in which a texture image is covered on a 3D space which is formed of a mesh.

Thereafter, the server may calculate image texture regularity of the detected texture image. In more detail, the server may calculate the image texture regularity of the detected texture image using a regularity filtering algorithm. That is, the server may generate a pixel value difference as a histogram in a specific direction, may analyze a pattern of the histogram, and may calculate the image texture regularity of the detected texture image.

When it is determined that the calculated image texture regularity has a set value or more, then the server may detect the detected texture image as an advertising region. Herein, enhancing of the image texture regularity may be done so that the detected texture image is suitable for an advertising region because the detected texture image is shown as an image which is similar to a plane or a curve.

Accordingly, because the front surface of the “A building” may not be recognized as a plane or curve, the server may verify that the front surface of the “A building” may not be an advertising region, may verify that the side surface of the “A building” may be the advertising region, and may detect the side surface of the “A building” as the advertising region.

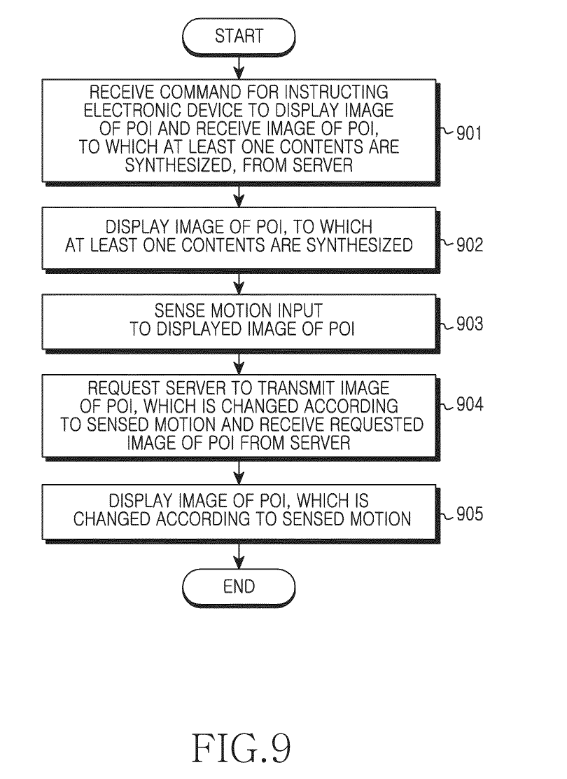

FIG. 9 is a flowchart illustrating a process of synthesizing advertising contents to an image of a POI and displaying the synthesized image in an electronic device according to an embodiment of the present disclosure.

Referring to FIG. 9, an electronic device may receive a command for instructing the electronic device to display an image of a POI and to receive an image of a POI, to which at least one contents are synthesized, from a server at operation 901. In more detail, when a title of the POI is received, the electronic device may request the server to transmit an image of the POI and the electronic device may receive the image of the POI, to which at least one contents are synthesized, from the server in order to display a 3D image of the received POI.

Thereafter, the electronic device may display the image of the POI, to which at least the one contents are synchronized, at operation 902. For example, when an “A area” is received as the POI, the electronic device may display a 3D image of the “A area”, to which at least the one contents from the server are synthesized. That is, the electronic device may display an image of the POI, wherein the image of the POI includes advertising contents that are synthesized to a synthesizable region from among image regions of the POI on the touch screen of the electronic device.

Thereafter, the electronic device may sense a motion, such as a gesture, that is input to the displayed image of the POI at operation 903. In more detail, the electronic device may detect gestures, such as a touch, a drag, a release, and any other similar and/or suitable gesture, may detect scroll operations, such as a scroll-up operation, a scroll-down operation, and any other similar and/or suitable scroll operation, and may sense scaling operations, including a magnifying operation, a de-magnifying operation, a zoom-in operation, a zoom-out operation, and any other similar and/or suitable scaling operation, on a certain region of the image of the POI. For example, the electronic device may receive a motion for magnifying a certain region of a 3D image of the “A area” displayed on the touch screen and may also receive a scrolling motion for displaying a region which is not displayed on the touch screen.

The electronic device may request the server to transmit an image of the POI, which is changed according to the sensed motion, and the electronic device may receive the requested image of the POI from the server at operation 904. In more detail, when the electronic device senses that a specific motion is input to the image of the POI, the electronic device may request the server to transmit the image of the POI and may receive the requested image of the POI from the server in order to display the image of the POI, which is changed according to the sensed motion.

The electronic device may display the image of the POI, which is changed according to the sensed motion, at operation 905. For example, it is assumed that the 3D image of the “A area” is displayed on the touch screen and advertising contents of a “B store” are synthesized to the displayed 3D image. In the above-described assumption, when the advertising contents of the “B store” displayed on the touch screen are selected, then the electronic device may reproduce a moving picture including information such as various menus of the “B store”, ingredients added to respective foods, and prices of respective menus.

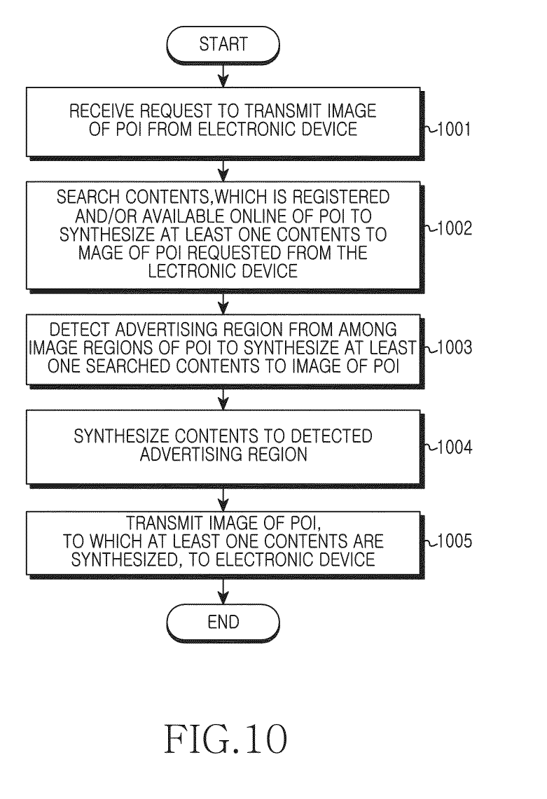

FIG. 10 is a flowchart illustrating a process of synthesizing advertising contents to an image of a POI and transmitting the synthesized image to an electronic device in a server according to an embodiment of the present disclosure.

Referring to FIG. 10, a server may receive the request to transmit an image of a POI from the electronic device at operation 1001. For example, the server may receive a request for indicating a position and/or a location of a “store which is located near an A region” as a 3D image.

The server may search for contents, which is registered and/or available online, of the POI in order to synthesize at least one contents to the requested image of the POI at operation 1002. In more detail, when the image of the POI is requested from the electronic device, then the server searches for advertising contents, which is registered and/or available online, of the POI in order to acquire a stored 3D image of the POI and synthesize the searched advertising contents to the acquired 3D image. For example, in the embodiment of FIG. 9, it is assumed that stores which register advertising messages in 3D images of the “A area” are a “B theater”, a “C bookstore”, and a “D restaurant”. In above-described assumption, when the server receives the request to transmit the 3D image of the “A area” from the electronic device, the server may search for advertising contents of the “B theater”, the “C bookstore”, and the “D restaurant” which are registered and/or available online, corresponding to the 3D image of the “A area”.

Thereafter, the server may detect an advertising region from among image regions of the POI, in order to synthesize at least the one searched region to an image of the POI at operation 1003. In more detail, the server may perform a process described below in order to detect an advertising region from among image regions of the POI. First of all, the server may detect a surface having a size greater than or equal to a set size from a 3D image, which is the image of the POI. The server may detect a texture image configuring the detected surface and may calculate an image texture regularity of the detected texture image. When it is determined that the calculated image texture regularity has a value greater than or equal to a set value, then the server may detect the detected texture image as an advertising region.

After detecting the advertising region at operation 1003, the server may synthesize the contents to the detected advertising region at operation 1004. Herein, the advertising region may be a region where the user may conveniently verify the image of the POI although registered advertising contents are synthesized among image regions of the POI. For example, the advertising region may be at least one of a wall of a building, a road region, a sidewalk region where there is no structure, a region whose image is not complicated such as a sea and a river, an advertising region like a real billboard among the image regions of the POI, or any other similar and/or suitable image regions of the POI.

After synthesizing the contents in operation 1004, the server may transmit the image of the POI, to which at least the one contents are synthesized, to the electronic device at operation 1005. Herein, the above-described advertising contents may be a fixed advertising image, a moving advertising icon and/or image, a guide message for verifying a position of the nearest store, or any other similar and/or suitable type of advertising contents.

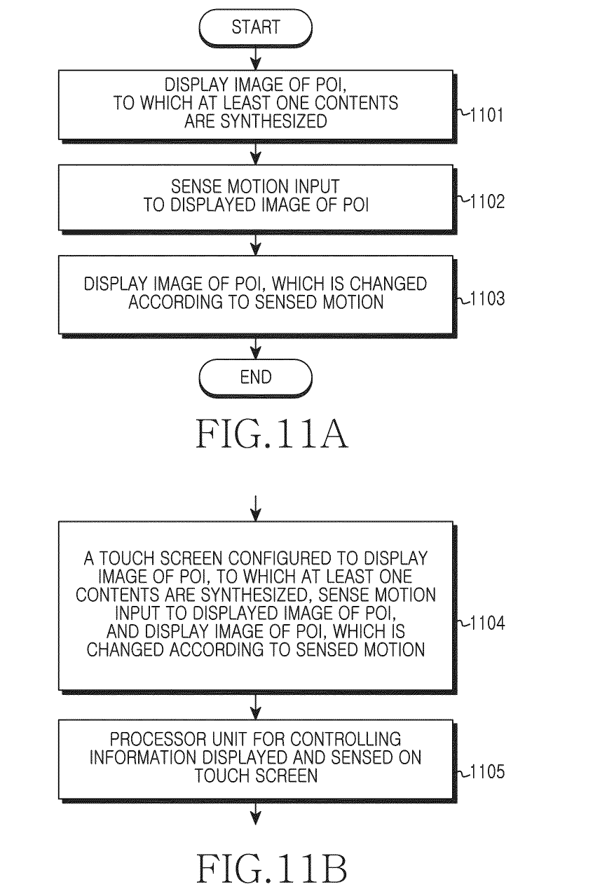

FIG. 11A is a flowchart illustrating a process of synthesizing advertising contents to an image of a POI in an electronic device according to an embodiment of the present disclosure.

Referring to FIG. 11A, the electronic device may display an image of a POI, to which at least the one contents are synchronized, at operation 1101. In more detail, the electronic device may receive a command for instructing the electronic device to display the image of the POI, may receive the image of the POI, to which at least the one contents are synthesized, from a server, and may display the image of the POI, to which at least the one contents are synthesized. For example, when an “A area” is received as the POI, then the electronic device may display a 3D image of the “A area”, to which at least the one contents received from the server are synthesized. That is, the electronic device may display an image of the POI where advertising contents are synthesized to a synthesizable region from among image regions of the POI on a touch screen of the electronic device.

Thereafter, the electronic device may sense a motion input to the displayed image of the POI at operation 1102. In more detail, the electronic device may detect gestures, such as a touch, a drag, and a release, may detect scroll operations, such as a scroll-up operation and a scroll-down operation, or may sense scaling operations including a magnifying operation and a de-magnifying operation, such as a zoom-in operation and a zoom-out operation, on a certain region of the image of the POI. For example, the electronic device may receive a motion for magnifying a certain region of a 3D image of the “A area” displayed on the touch screen and may also receive a scrolling motion for displaying a region which is not displayed on the touch screen.

The electronic device may display the image of the POI, which is changed according to the sensed motion at operation 1103. For example, it is assumed that the 3D image of the “A area” is displayed on the touch screen and advertising contents of a “B store” are synthesized to the displayed 3D image. In the above-described assumption, the electronic device may display a guide message for guiding a position of a “B store” together on a changed 3D image, which is not displayed on the touch screen.

FIG. 11B is a block diagram illustrating configuration of an electronic device for synthesizing advertising contents to an image of a POI according to an embodiment of the present disclosure.

Referring to FIG. 11B, a touch screen 1104 of the electronic device may be configured to display an image of a POI, to which at least one contents are synthesized, may be configured to sense a motion input to the displayed image of the POI, and may be configured to display the image of the POI, which is changed according to the sensed motion. For example, when a certain movie advertisement displayed on the electronic device is selected, then the electronic device may reproduce a preview of the selected movie as a video image and may provide information about the movie to the user via the touch screen 1104.

A processor unit 1105 of the electronic device may be configured to control information displayed and sensed on the touch screen. For example, the processor unit may be any suitable hardware element, and may include a memory, an interface, one or more processors, a peripheral interface, an Integrated Circuit (IC), an Application Specific IC (ASIC), a controller, an Erasable Programmable Read Only Memory (EPROM), or any other similar and/or suitable hardware element. In some cases, the whole processor unit may be referred to as a processor.

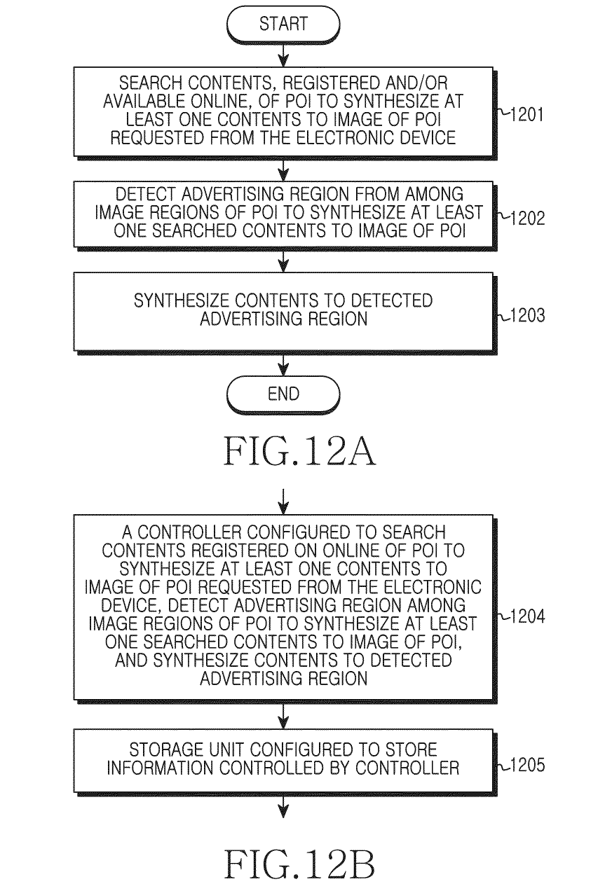

FIG. 12A is a flowchart illustrating a process of synthesizing advertising contents to an image of a POI in a server according to an embodiment of the present disclosure.

Referring to FIG. 12A, the server may search contents, which is registered and/or available online, of the POI in order to synthesize at least one contents to the image of the POI requested from an electronic device at operation 1201. In more detail, when the image of the POI is requested from the electronic device, then the server may search advertising contents that are registered and/or available online and that correspond to the POI in order to acquire a stored 3D image of the POI and in order to synthesize advertising contents to the acquired 3D image.

Thereafter, the server may detect an advertising region, from among image regions of the POI, in order to synthesize at least the one searched region to an image of the POI at operation 1202. The server may detect a surface having a size greater than or equal to a set size from a 3D image, which is the image of the POI. The server may detect a texture image configuring the detected surface and may calculate an image texture regularity of the detected texture image. When it is determined that the calculated image texture regularity has a value greater than or equal to a set value, then the server may detect the detected texture image as an advertising region.

The server may synthesize the contents to the detected advertising region at operation 1203. Herein, the advertising region may be a region where the user may conveniently verify the image of the POI although registered advertising contents are synthesized among image regions of the POI. For example, the advertising region may be at least one of a wall of a building, a road region, a sidewalk region where there is no structure, a region whose image is not complicated such as a sea and a river, and an advertising region like a real billboard, from among image regions of the POI. Thereafter, after detecting the advertising region, the server may transmit the image of the POI, to which at least the one contents are synthesized, to the electronic device.

FIG. 12B is a block diagram illustrating configuration of a server for synthesizing advertising contents to an image of a POI according to an embodiment of the present disclosure.

First of all, a controller 1204 of the server may be configured to search for contents registered and/or available online and corresponding to a POI, in order to synthesize at least one contents to an image of the POI requested from an electronic device, may be configured to detect an advertising region from among image regions of the POI in order to synthesize at least one of the searched contents to the image of the POI, and may be configured to synthesize contents to the searched advertising region. For example, the server may detect a wall of a building, a road region, a sidewalk region where there is no structure, a region whose image is not complicated such as a sea and a river, and an advertising region like a real billboard, from among the image regions of the POI and may transmit the image of the POI, to which at least the one contents are synthesized, to the electronic device.

Thereafter, a storage unit 1205 of the server may be configured to store information controlled by the controller. The storage unit 1205 of the server may include a program storage unit for storing programs for controlling operation of the server and a data storage unit for storing data generated while the programs are performed. The storage unit 1205 may be any suitable hardware element that includes a non-volatile computer readable storage medium, such as a Random Access Memory (RAM), a Read Only Memory (ROM), a magnetic storage medium, an optical storage medium, or any other similar and/or suitable hardware element for storing information.

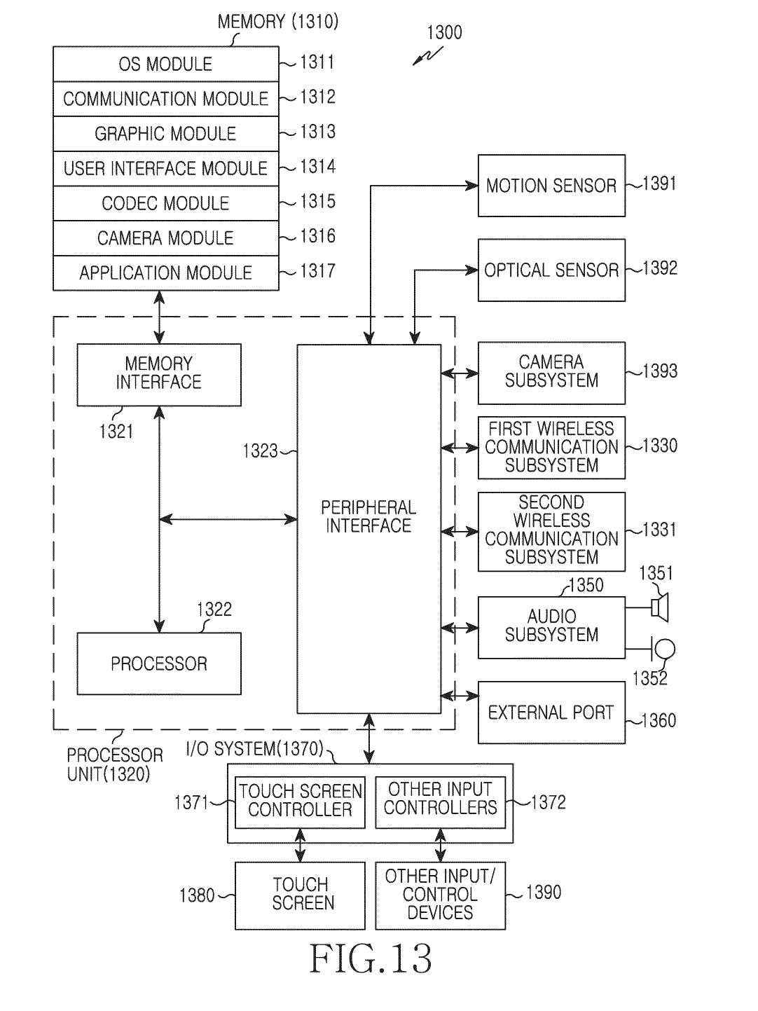

FIG. 13 is a block diagram illustrating configuration of an electronic device according to an embodiment of the present disclosure.

An electronic device 1300 may be a portable electronic device. The electronic device 1300 may be an apparatus, such as a portable terminal, a mobile phone, a mobile pad, a media player, a tablet computer, a handheld computer, a personal computer (PC), a Personal Digital Assistant (PDA), any combination thereof, or any other similar and/or suitable electronic device. The electronic device 1300 may be a certain portable electronic device including a device in which two or more functions are combined among these apparatuses.

This electronic device 1300 includes a memory 1310, a processor unit 1320, a first wireless communication subsystem 1330, a second wireless communication subsystem 1331, an external port 1360, an audio subsystem 1350, a speaker 1351, a microphone 1352, an Input/Output (I/O) system 1370, a touch screen 1380, other input/control devices 1390, a motion sensor 1391, an optical sensor 1392, and a camera subsystem 1393. The memory 1310 and the external port 1360 may respectively be a plurality of memories and external ports.

The processor unit 1320 may include a memory interface 1321, at least one processor 1322, and a peripheral interface 1323. In some cases, the whole processor unit 1320 is referred to as a processor.

The processor 1322 executes several software programs and performs several functions for the electronic device 1300. Also, the processor 1322 performs process and control for voice and data communication. In addition to these normal functions, the processor 1322 may execute a specific software module or instruction set stored in the memory 1310 and may perform several specific functions corresponding to the module. That is, the processor 1322 interworks with software modules stored in the memory 1310 and performs various embodiments of the present disclosure.

The processor 1322 may include at least one data processor, an image processor, and a codec. The processor 1322 may separately include the data processor, the image processor, or the codec. Also, the processor 1322 may include several processors for performing different functions. The peripheral interface 1323 connects the I/O system 1370 of the electronic device 1300 and several peripheral devices to the processor 1322 and the memory 1310 through the memory interface 1321.

A variety of components of the electronic device 1300 may be coupled by one or more communication buses (not shown) or stream lines (not shown).

The external port 1360 is used to connect the electronic device 1300 to another electronic device (not shown) directly or to connect the electronic device 1300 to another electronic device (not shown) indirectly through a network, e.g., the Internet, an intranet, a wireless Local Area Network (LAN), or any other similar and/or suitable network. For example, the external port 1360 may be a Universal Serial Bus (USB) port, a firewire port, or any other similar and/or suitable port for connecting to external devices.

The motion sensor 1391 and the optical sensor 1392 may connect to the peripheral interface 1323 and may perform several functions. For example, the motion sensor 1391 and the optical sensor 1392 may connect to the peripheral interface 1323, may sense motion of the electronic device 1300, and may sense light from the outside. Furthermore, a position measurement system and other sensors, such as a temperature sensor and a bio-sensor, may connect to the peripheral interface 1323 and may perform related functions.

The camera subsystem 1393 may perform a camera function like a photo and video clip recording function.

The optical sensor 1392 may be a Charge Coupled Device (CCD) or a Complementary Metal-Oxide Semiconductor (CMOS) device.

A communication function is performed through the first and second wireless communication subsystems 1330 and 1331. Each of the first and second wireless communication subsystems 1330 and 1331 may include, although not shown, at least one of a Radio Frequency (RF) receiver, an RF transmitter, and an RF transceiver and/or at least one of a beam receiver, a beam transmitter, and a beam transceiver for beams such as an infrared ray or any other similar and/or suitable beam or ray. The first communication subsystem 1330 and the second communication subsystem 1331 may be classified according to a communication network through which the electronic device 1300 communicates. For example, the communication network may be, at least one of a Global System for Mobile communication (GSM) network, an Enhanced Data GSM Environment (EDGE) network, a Code Division Multiple Access (CDMA) network, a Wideband-CDMA (W-CDMA) network, a Long Term Evolution (LTE) network, an Orthogonal Frequency Division Multiple Access (OFDMA) network, a Wireless Fidelity (Wi-Fi) network, a Worldwide Interoperability for Microwave Access (WIMAX) network, a Bluetooth network, and any other similar and/or suitable communication network type. Each of the first and second communication subsystems 1330 and 1331 may include a communication subsystem designed to be operated through the communication network. The first and second wireless communication subsystems 1330 and 1331 may be combined and configured as one wireless communication subsystem.

The audio subsystem 1350 may connect to the speaker 1351 and the microphone 1352 and may be responsible for inputting and outputting an audio stream, such as a voice recognition function, a voice copy function, a digital recording function, and a phone call function. That is, the audio subsystem 1350 communicates with a user through the speaker 1351 and the microphone 1352. The audio subsystem 1350 receives a data stream through the peripheral interface 1323 of the processor unit 1320 and converts the received data stream into an electric stream. The converted electric stream is transmitted to the speaker 1351. The speaker 1351 converts the electric stream into a sound wave to which the user may listen and outputs the converted sound wave. The microphone 1352 converts a sound wave transmitted from a user and/or other people and/or other sound sources into an electric stream. The audio subsystem 1350 receives the converted electric stream from the microphone 1352. The audio subsystem 1350 converts the received electric stream into an audio data stream and transmits the converted audio data stream to the peripheral interface 1323. The audio subsystem 1350 may include an attachable and detachable earphone, headphone, or headset.

The I/O system 1370 may include a touch screen controller 1371 and other input controllers 1372. The touch screen controller 1371 may be coupled to the touch screen 1380. The touch screen 1380 and the touch screen controller 1371 may detect contact and/or motion or a stopping of contact and/or motion using at least one of capacitive, resistive, infrared ray, and surface acoustic wave technologies for determining one or more contact points with the touch screen 1380. However, the present disclosure is not limited thereto, and the touch screen 1380 and the touch screen controller 1371 may detect any type of input to the touch screen 1380 using any suitable detection technology, such as a multi-touch sensing technology including other proximity sensor arrangement or other elements. The other input controllers 1372 may be coupled to the other input/control devices 1390. The other input/control devices 1390 may be pointer devices such as one or more buttons, a rocket switch, a thumb-wheel, a dial, a stick, a stylus, or any other similar and/or suitable input/control device.

The touch screen 1380 provides an input/output interface between the electronic device 1300 and the user. That is, the touch screen 1380 transmits a touch input of the user to the electronic device 1300. Also, the touch screen 1380 may be configured to display output from the electronic device 1300 to the user. That is, the touch screen 1380 displays visual output to the user. This visual output may be a text type, a graphic type, a video type, a combined type of them, and any other similar and/or suitable visual output type.

The touch screen 1380 may be any one of several display types. For example, the touch screen 1380 may be, but is not limited to, a Liquid Crystal Display (LCD), a Light Emitting Diode (LED), a Light emitting Polymer Display (LPD), an Organic Light Emitting Diode (OLED), an Active Matrix Organic Light Emitting Diode (AMOLED), or a Flexible LED (FLED). The touch screen 1380, according to an embodiment of the present disclosure, may display an image of a POI, to which at least one contents are synthesized, may sense a motion input to the displayed image of the POI, and may display the image of the POI, which is changed according to the sensed motion. The touch screen 1380, according to an embodiment of the present disclosure, may receive a command for instructing the electronic device to display the image of the POI and may display the image of the POI that has at least one contents synthesized to at least one synthesizable region from among image regions of the POI, such that the image of the POI is not hidden. Also, the touch screen 1380, according to an embodiment of the present disclosure, may allow the user to select at least one contents which are synthesized to the image of the POI, to verify whether the selected contents are contents for reproducing a moving picture, and the touch screen 1380 may reproduce a moving picture for advertising specific goods and a specific service. Also, the touch screen 1380, according to an embodiment of the present disclosure, may verify that the selected contents are contents for guiding, directing, and/or indicating the user to the nearest store on the image of the POI, and may display a guide message such that the user may verify a position of the nearest store on the image of the POI.

The memory 1310 may be coupled to the memory interface 1321. The memory 1310 may include a Random Access Memory (RAM), such as one or more magnetic storages, a non-volatile memory, one or more optical storages, and/or a flash memory, e.g., a NAND flash memory or a NOR flash memory.

The memory 1310 stores software components. The software components may include an Operating System (OS) module 1311, a communication module 1312, a graphic module 1313, a user interface module 1314, a CODEC module 1315, a camera module 1316, at least one application module 1317, and any other similar and/or suitable modules that may be stored on the electronic device 1300. Also, the modules which are the software components may be expressed in a set of instructions. Accordingly, the modules may be expressed in an instruction set and/or the modules may be expressed in programs.

The OS module 1311, e.g., an embedded OS such as Windows, Linux, Darwin, RTXC, UNIX, OS X, or VxWorks, includes several software components for controlling a general system operation. For example, control of this general system operation means memory management and control, storage hardware and/or device control and management, power control and management, and other similar and/or suitable system operations. This OS module 1311 also performs a function for smoothly communicating between several hardware components and/or devices and software components and/or modules. In a case where it is verified that there is a difference greater than or equal to a set picture vector value and a picture vector value is held in a range of the set picture vector values, then the memory 1310 of an embodiment of the present disclosure may register a sound source file portion corresponding to a time when a reference picture vector value is extracted as a highlight estimation interval.

The communication module 1312 may communicate with other electronic devices, such as a computer, a server, and/or a portable terminal, through the first and second wireless communication subsystems 1330 and 1331 or the external port 1360. The communication module 1312, according to an embodiment of the present disclosure, may request a server to transmit an image of a POI and may receive an image of the POI, to which at least one contents are synthesized, from the server. Also, the communication module 1312, according to an embodiment of the present disclosure, may request the server to transmit an image of a POI, which is changed according to a sensed motion, and may receive the image of the POI requested from the server.

The graphic module 1313 includes several software components for providing and displaying graphics on the touch screen 1380. The term “graphics” may refer to characters, texts, web pages, icons, digital images, videos, animations, and any other similar and/or suitable element that may be displayed on a screen, are included.

The user interface module 1314 includes several software components related to a user interface. The user interface module 1314 includes contents about whether a state of a user interface is changed to any state, whether a state of a user interface is changed in any condition, or any other similar and/or suitable changes of states of a user interface.

The CODEC module 1315 may include software components related to encoding and decoding of video files. The CODEC module 1315 may include a video stream module, such as a Motion Picture Experts Group (MPEG) module and/or an H.264 module. Also, the CODEC module 1315 may include a code module for several audio files, such as Advanced Audio Coding (AAC) files, Adaptive Multi-Rate (AMR) files, Widows Media Audio (WMA) files, or any other similar and/or suitable type of files. Also, the CODEC module 1315 includes an instruction set corresponding to one embodiment of the present disclosure.

The camera module 1316 includes cameral-related software components capable of performing camera-related processes and functions.

The application module 1317 may include a browser function, an email function, an instant message function, a word processing function, a keyboard emulation function, an address book function, a touch list function, a widget function, a Digital Right Management (DRM) function, a voice recognition function, a voice copy function, a position determining function, a location based service function, and any other similar and/or suitable function that may be executed on the electronic device 1300.

A variety of functions of the electronic device 1300, which are described above or to be described later, may be executed by at least one stream processing, at least one hardware, including an ASIC, at least one software, and/or combination of thereof

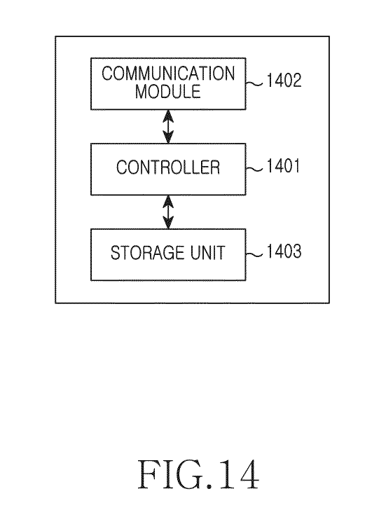

FIG. 14 is a block diagram illustrating configuration of a server according to an embodiment of the present disclosure.

Referring to FIG. 14, a server may include a controller 1401, a communication module 1402, and a storage unit 1403.

The controller 1401 may be configured to control an overall operation of the server. For example, the controller 1401 may search contents registered and/or available online and corresponding to a POI in order to synthesize at least one contents to an image of the POI requested from an electronic device, may detect an advertising region from among image regions of the POI in order to synthesize at least one of the searched contents to the image of the POI, and may synthesize the contents to the detected advertising region. Also, the controller 1401 may detect a surface having a size greater than or equal to a set size from a 3D image, which is the image of the POI, may detect a texture image configuring the detected surface, and may calculate an image texture regularity of the detected texture image. If it is determined that the calculated image texture regularity the greater than or equal to a set value, then the controller 1401 may detect the detected texture image as an advertising region. Also, the controller 1401 may detect a surface having a size greater than or equal to a set size using an RANSAC algorithm and may calculate image texture regularity using a regularity filtering algorithm.

The communication module 1402 may be configured to process signals transmitted and/or received through an antenna in order to perform voice and data communication. For example, the communication module 1402 may receive a request to transmit an image of a POI from the electronic device and may transmit the image of the POI, to which at least one contents are synthesized, to the electronic device.

The storage unit 1403 may be configured to include a program storage unit for storing programs for controlling operations of the server and to include a data storage unit for storing data generated while the programs are executed.

As described above, the controller 1401 may perform an overall operation of the server. The communication module 1402, the controller 1401, and the storing unit 1403 are shown separately in order to describe respective functions of them separately. However, the server may be implemented such that the controller 1401 may be configured to process all functions of the server and may include functions recited as being performed by the communication module 1402 and the storage unit 1403. Also, the controller 1401 may be configured to process only some of the functions noted above.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of an electronic device, the method comprising:
displaying an image of a Point of Interest (POI), to which at least one contents are synthesized;
sensing a motion input to the displayed image of the POI; and
displaying the image of the POI that has been changed according to the sensed motion.

2. The method of claim 1, further comprising:
receiving a command for instructing the electronic device to display the image of the POI;
requesting a server to transmit the image of the POI; and
receiving the image of the POI to which the at least one contents are synthesized, from a server.

3. The method of claim 1, wherein the displaying of the image of the POI, to which at least the one contents are synthesized, comprises displaying the image of the POI that includes the at least one contents synthesized to at least one synthesizable region from among image regions of the POI such that the image of the POI is not obscured.

4. The method of claim 1, wherein the sensing of the motion input to the displayed image of the POI comprises selecting the at least one contents which are synthesized to the image of the POI.

5. The method of claim 1, further comprising:
requesting a server to transmit the image of the POI that has been changed according to the sensed motion; and
receiving the requested image of the POI from a server.

6. The method of claim 1, wherein the displaying of the image of the POI that has been changed according to the sensed motion comprises:
verifying that selected contents are contents used to reproduce a moving picture; and
reproducing the moving picture for advertising at least one of goods and services.

7. The method of claim 1, wherein the displaying of the image of the POI that has been changed according to the sensed motion comprises:
verifying that selected contents are contents used to guide a user to the nearest store on the image of the POI; and
displaying a guide message to verify a position of the nearest store on the image of the POI.

8. A method of a server, the method comprising:
searching for contents that are at least one of registered and available online and that correspond to a Point of Interest (POI), in order to synthesize at least one contents to an image of the POI that is requested by an electronic device;
detecting an advertising region from among image regions of the POI in order to synthesize the at least one searched contents to the image of the POI; and
synthesizing the contents to the detected advertising region.

9. The method of claim 8, further comprising receiving a request to transmit the image of the POI from the electronic device.

10. The method of claim 8, wherein the detecting of the advertising region from among the image regions of the POI comprises:
detecting a surface having a size greater than or equal to a set size from a 3D image of the POI;
detecting a texture image configuring the detected surface;
calculating an image texture regularity of the detected texture image; and
detecting the detected texture image as the advertising region when the calculated image texture regularity is determined to have a value greater than or equal to a set value.

11. The method of claim 10, wherein the detecting of the surface having the size greater than or equal to the set size from the 3D image of the POI comprises detecting the surface having the size greater than or equal to the set size using a RANdom SAmple Consensus (RANSAC) algorithm.

12. The method of claim 10, wherein the calculating of the image texture regularity of the detected texture image comprises calculating the image texture regularity using a regularity filtering algorithm.

13. The method of claim 8, further comprising transmitting the image of the POI, to which the at least one contents are synthesized, to the electronic device.

14. An electronic device comprising:
a touch screen configured to display an image of a Point of Interest (POI), to which at least one contents are synthesized, configured to sense a motion input to the displayed image of the POI, and configured to display the image of the POI that has been changed according to the sensed motion; and
a processor unit configured to control information displayed and sensed on the touch screen.

15. The electronic device of claim 14, wherein the touch screen receives a command for instructing the electronic device to display the image of the POI, and
wherein the electronic device further comprises a communication module configured to request a server to transmit the image of the POI and configured to receive the image of the POI, to which the at least one contents are synthesized, from a server.

16. The electronic device of claim 14, wherein the touch screen displays the image of the POI having the at least one contents synthesized to at least one synthesizable region from among image regions of the POI such that the image of the POI is not obscured.

17. The electronic device of claim 14, wherein the touch screen selects the at least one contents which are synthesized to the image of the POI.

18. The electronic device of claim 14, further comprising a communication module configured to request a server to transmit the image of the POI that has been changed according to the sensed motion and configured to receive the requested image of the POI from a server.

19. The electronic device of claim 14, wherein the touch screen is configured to verify that selected contents are contents used to reproduce a moving picture, and
wherein the touch screen in configured to reproduce the moving picture for advertising at least one of goods and services.

20. The electronic device of claim 14, wherein the touch screen is configured to verify that selected contents are contents used to guide a user to the nearest store on the image of the POI, and
wherein the touch screen is configured to display a guide message to verify a position of the nearest store on the image of the POI.

21. A server comprising:
a controller configured to search for contents that is at least one of registered and available online and that corresponds to a POI in order to synthesize at least one contents to an image of the POI requested by an electronic device, configured to detect an advertising region from among image regions of the POI in order to synthesize the at least one searched contents to the image of the POI, and configured to synthesize the contents to the detected advertising region; and
a storing unit configured to store information controlled by the controller.

22. The server of claim 21, further comprising a communication module for receiving a request to transmit the image of the POI from the electronic device.

23. The server of claim 21, wherein the controller is configured to detect a surface having a size greater than or equal to a set size from a 3D image of the POI, configured to detect a texture image configuring the detected surface, configured to calculate an image texture regularity of the detected texture image, and configured to detect the detected texture image as the advertising region when the calculated image texture regularity is determined to have a value greater than or equal to a set value.

24. The server of claim 23, wherein the controller detects the size of the surface using a RANdom SAmple Consensus (RANSAC) algorithm.

25. The server of claim 23, wherein the controller calculates the value of the image texture regularity using a regularity filtering algorithm.

26. The server of claim 21, further comprising a communication module configured to transmit the image of the POI, to which the at least one contents are synthesized, to the electronic device.
